(19) United States
(12) Patent Application Publication
(10) Pub. No.: US 2017/0287410 A1
(43) Pub. Date: Oct. 5, 2017

(54) Modular Electrofluidic Display Device

(71) Applicant: Siu Wai Ho, Hong Kong (HK)

(72) Inventor: Siu Wai Ho, Hong Kong (HK)

(21) Appl. No.: 15/090,560

(22) Filed: Apr. 4, 2016

(51) Int. Cl. G09G 3/34; G09G 5/14; G09G 3/20; G02B 26/00

(52) U.S. Cl. CPC G09G 3/348; G02B 26/005; G09G 5/14; G09G 3/2003

(57) ABSTRACT

According to embodiments of the invention, apparatuses and devices are directed towards a modular electrofluidic display. The electrofluidic display may be capable of displaying imagery both on a front side and a rear side of a display. This is carried out by adding a fourth oil layer to a display panel which traditionally may have employed two or three oil layers. In a traditional display mode, the color of the oil on the fourth layer may serve as the background color of the pixel. Light from the rear is blocked by the fourth oil layer. In a mode where both sides of the display are required to display images, the oil in the background layer may be displaced with a voltage applied so that light can traverse to all the colored oils from both front end as well as the back end of the display.

### FIELD OF THE INVENTION

The present invention generally relates to display systems and, more particularly, to electrofluidic display pixels included as display modules usable in displays and display systems.

### BACKGROUND OF THE INVENTION

Display devices like LCDs are used in computers, tablets, mobile phones, and other devices. Instead of LCDs, for example, (polymer) LED display devices are also being used for a wide variety of applications. Apart from these display effects that are well established by now other display techniques are evolving like electrophoretic displays, which are suitable for paper white applications. The present technology is based on a principle called electro-wetting using electrofluidic technology. The invention provides new ways of using this principle in which one of the fluids in a first state adjoins a greater part of the first plate and in the second state the other fluid at least partly adjoins the first plate. If for instance a first fluid is a colored oil and the second fluid is water, a two layer system is provided which comprises a water layer and an oil layer. However, if a voltage is applied between the water and an electrode on the first plate, the oil layer moves aside or breaks up due to electrostatic forces. Since parts of the water are capable of penetrating the oil layer the picture element becomes partly transparent.

Typically an electrofluidic display device displays a pixel through this mechanism known as electrowetting, which involves modifying the surface tension of liquids on a solid surface within a pixel structure by applying a voltage or electrical potential difference. Without a voltage, colored oil within the pixel structure forms a continuous film and the color is visible to the consumer. When a voltage is applied to the display pixel the oil is displaced and the pixel becomes transparent to the consumer. When different pixels are independently activated, the display can show content like an photograph or a video.

Multiple colors of oils can be used together within a pixel structure. In one example, the top oil may have a cyan color characteristic to present a cyan color to the viewer, with the next lower layer containing oil with a magenta color characteristic to present a magenta color to the viewer, and third oil may have a yellow color characteristic to present a yellow color to the viewer. Accordingly, the fluids of display pixel may cooperate to form the desire color scheme, with each of the grouped display pixels providing a portion of the desired color for a viewing area.

Current electrofluidic displays include a front portion with a display area and a rear portion that contains non-viewable areas. In other words, electrofluidic displays can be viewed from one side only. However, in principle, electrofluidic displays do not require backlight to operate. Instead, electrofluidic displays simply take advantage of incoming light as a source of light. Therefore, there is a need for electrofluidic displays to support displaying images from both the front side and the rear side.

### SUMMARY OF THE INVENTION

According to embodiments of the invention, apparatuses and devices are directed towards a modular electrofluidic display. The electrofluidic display may be capable of displaying imagery both on a front side and a rear side of a display. This is carried out by adding a fourth oil layer to a display panel which traditionally may have employed two or three oil layers. In a traditional display mode, the color of the oil on the fourth layer may serve as the background color of the pixel. Light from the rear is blocked by the fourth oil layer. In a mode where both sides of the display are required to display images, the oil in the background layer may be displaced with a voltage applied so that light can traverse to all the colored oils from both front end as well as the back end of the display.

In one embodiment of the disclosed technology, a modular EFT display is composed of one or more of the following components: a) a display panel; b) an EFT module, which includes a front side and a rear side, is located within an area of the display panel; c) a display driver control; d) a connector included in the EFT module for carrying a plurality of electronic signals of different voltages; e) a receptor included in the display panel, wherein the connector is configured to make contact with the receptor; f) an upper plate disposed at the front side of the EFT module; g) a first oil layer; h) a first fluid layer being a conductive fluid matter that is adapted to a first electric potential element; i) a second oil layer being a non-conductive fluid matter; j) a second fluid layer being a conductive fluid matter that is adapted to a second electric potential element; k) a third oil layer being a non-conductive fluid matter; l) a third fluid layer being a conductive fluid matter that is adapted to a third electric potential element; m) a fourth oil layer being a non-conductive fluid matter that is adapted to a fourth electric potential element; n) a lower plate disposed at the rear side of the EFT module; and/or o) a pixel structure.

The entirety of the components may form an isolated space. That is, a vacuum or concealed area is formed such that liquid, oil and/or other components are confined to the display. In further embodiments, the EFT display may contain a housing frame made of elastic material forming as an insulating element embedding the pixel structure. Still further, the EFT display may employ another EFT module controlled by the display driver control located on another location within the display panel.

In a further embodiment of the disclosed technology, the first oil layer may contain oil of a cyan color, the second oil layer may contain oil of a magenta color, and/or the third oil layer contains oil of yellow color. Furthermore, the fourth oil layer may contain oil of a given background color. The background color may be black, white or any other color. A black color may be shown from the front side of the EFT module when the first, second, and third electric potential elements are disengaged. Alternatively, a white color may be shown from the front side of the EFT module when the first, second, and third electric potential elements are disengaged.

In another embodiment of the disclosed technology, a red color is shown from the front side of the EFT module when the first electric potential element is engaged while the second, and third electric potential elements are disengaged. A blue color may be shown from the front side of the EFT module when the third electric potential element is engaged while the first and second electric potential elements are disengaged. Further, a green color may be shown from the front side of the EFT module when the second electric potential element is engaged while the first and third electric potential elements are disengaged.

In a further embodiment, the background color may be shown from the front side of the EFT module when the first, second, and third electric potential elements are engaged while the fourth electric potential element is disengaged. Transparency may be shown from the front side of the EFT module when the first, second, third, and fourth electric potential elements are engaged. That is, light will travel through the front side in this arrangement. Alternatively, transparency may be apparent from the rear side of the EFT module when the first, second, third, and fourth electric potential elements are engaged.

A better understanding of the disclosed technology will be obtained from the following brief description of drawings illustrating exemplary embodiments of the disclosed technology.

### BRIEF DESCRIPTION OF THE DRAWINGS

FIG. 1 shows a prior art cross section of a display.

FIG. 2 shows a prior art cross section of an electrofluidic display having two layers of oil.

FIG. 3 shows a prior art cross section of an electrofluidic display having three layers of oil.

FIG. 4 shows a cross section of an electrofluidic display having four layers of oil according to embodiments of the disclosed technology.

FIG. 5 shows the display in a black state according to embodiments of the disclosed technology.

FIG. 6 shows the display in a red state according to embodiments of the disclosed technology.

FIG. 7 shows the display in a blue state according to embodiments of the disclosed technology.

FIG. 8 shows the display in a green state according to embodiments of the disclosed technology.

FIG. 9 shows the display in a semi-transparent state according to embodiments of the disclosed technology.

FIG. 10 shows the display in a fully transparent state according to embodiments of the disclosed technology.

FIG. 11 shows a perspective stand-alone view of the display panel according to embodiments of the disclosed technology.

FIG. 12 shows a perspective stand-alone view of the display panel with a display driver control according to embodiments of the disclosed technology.

FIG. 13 shows a high-level block diagram of a microprocessor device that may be used to carry out the disclosed technology.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

Embodiments disclose an electrofluidic (also commonly referred to as “electrowetting”) display device. The electrofluidic display device utilizes the adjusting of hydrophilic degrees of a pixel structure and the arrangement of the pixel structure, so that the filling amount of an oil in the pixel region is defined by the pixel structure during a dip coating process. Imagery may be displayed on a rear portion of the display by displacing a fourth layer of oil in the EFT display module.

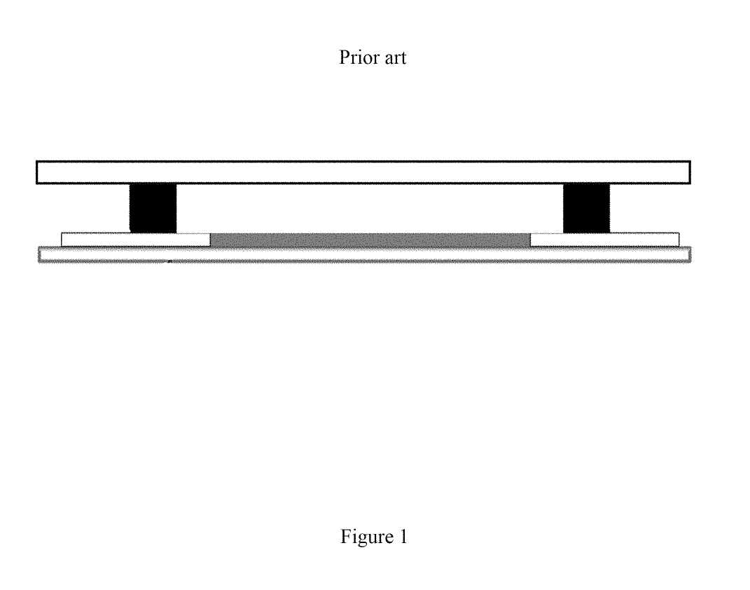

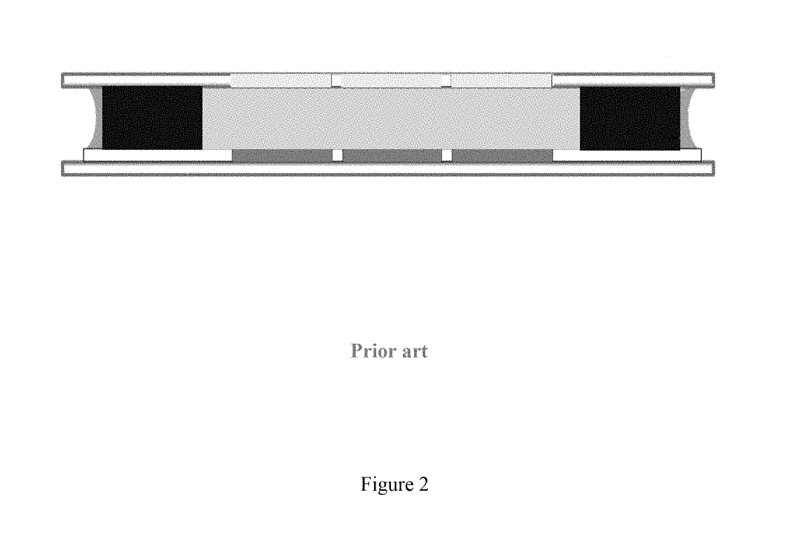

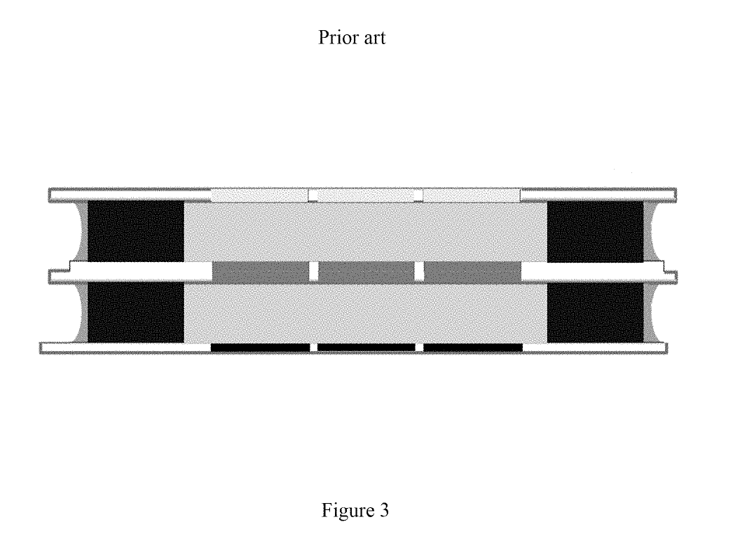

Referring now to FIG. 1, a prior art cross section of a display is depicted. FIG. 2 shows a prior art cross section of an electrofluidic display having two layers of oil, while FIG. 3 shows a prior art cross section of an electrofluidic display having three layers of oil.

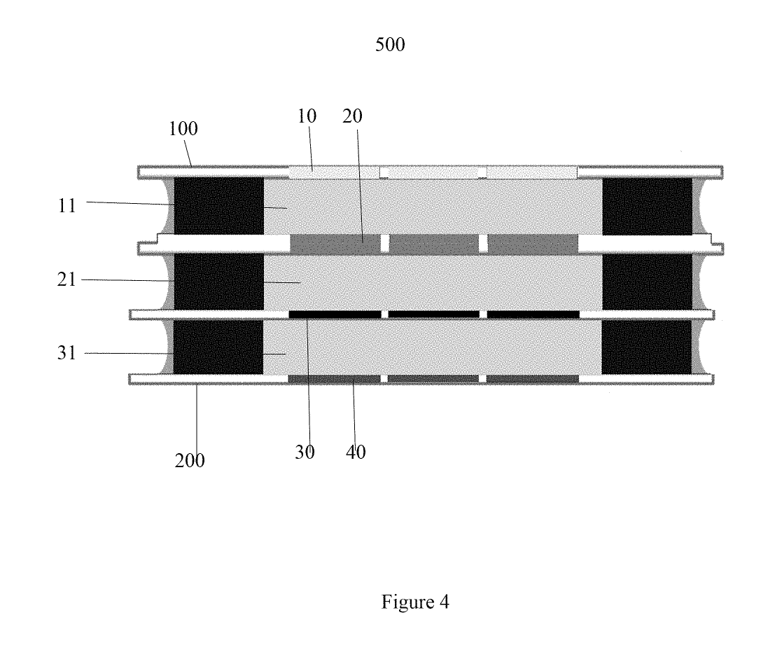

FIG. 4 shows a cross section of an electrofluidic display having four layers of oil according to embodiments of the disclosed technology. A display panel 1000 has an EFT module 500. The EFT Module 500 generally has an upper plate 100 which is opposed by a lower plate 200. In embodiments, the upper plate 100 and the lower plate 200 may be composed of rigid substrates such as glass and/or silicon wafer. Alternatively, the upper plate 100 and the lower plate 200 may be composed of flexible substrates formed of poly(ethylene terephthalate) (PET), polyethylenenaphthalate (PEN), polycarbonate (PC), polyethersulfone (PES), polyimide (PI) or a metal foil.

A first oil layer 10 is disposed on the top plate 100. A second oil layer 20, a third oil layer 30 and a fourth oil layer 40 are layered under the top plate 100, extending all the way to the bottom plate 200. The fourth oil layer 40 is disposed on the bottom plate 200. Each oil layer 10, 20, 30, 40 is associated with an associated conductive fluid layer 11, 12, 13, 14, respectively. Further each fluid layer 11, 12, 13, 14 may be associated with an electric potential element.

The oils and fluids may come into contact with one another, but will not mix to form a homogenous mixture due to their chemical structures. For example, the oil may be silicone oil while the fluid may be a water, salt and/or alcohol mixture. Other chemicals may be used for the oils and/or fluids such as, but not limited to, silicon oxide (SiOx), silicon nitride (SiNx) oxynitride (SiOxNy), aluminum oxide (Al2O3), tantalum oxide (Ta2O3), titanium oxide (TiO2), barium titanate (BaTiO3), polyvinylidene difluoride (PVDF), combinations thereof or a polymer with a dielectric constant (k) being larger than 2. Also, the hydrophobic layer may comprise a polymer containing a fluorine containing polymer, a diamond like carbon (DLC) film, or a self-assembled silane molecular. The self-assembled silane molecular may comprise octadecyl trichlorosilane (OTS), 3,3,3 trifluoro-propylmethyl dichlorosilane (PMDCS), tridecafluoro-1,1,2,2-tetrahydrooctyl trichlorosilane (FOTS), heptadecafluoro-1,1,2,2-tetrahydrodecyl trichlorosilane (FDTS), dodecyl trichlorosilane (DDTCS), dimethyldichlorosilane (DDMS), (vinylundecyl tirchlorosilane (V11TCS) or aminopropyl trimethoxysilane (APTMS).

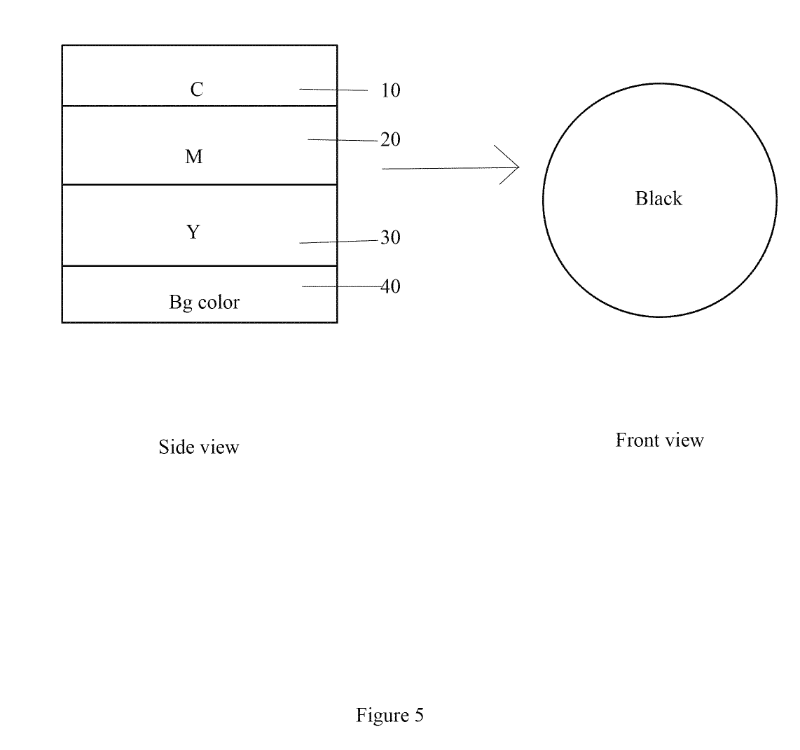

FIG. 5 shows the display in a black state according to embodiments of the disclosed technology. In the depicted embodiment of the disclosed technology, the first oil layer 10 may contain oil of a cyan color, the second oil layer 20 may contain oil of a magenta color, and/or the third oil layer 30 contains oil of yellow color. Furthermore, the fourth oil layer 40 may contain oil of a given background color. This state may be triggered when no external voltage is applied to the fluids. Thus, this state may represent the resting or off state of the display.

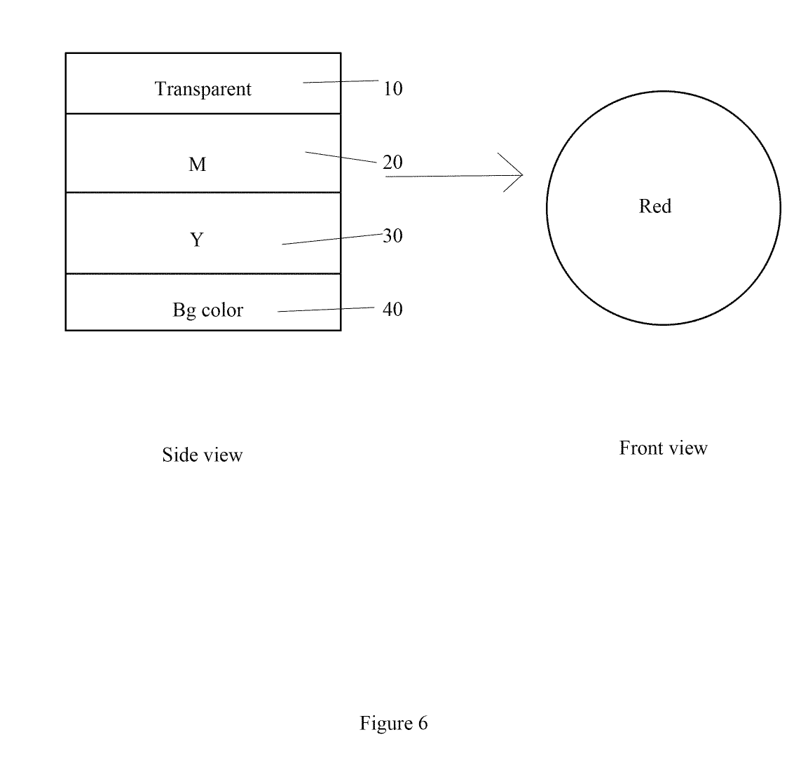

FIG. 6 shows the display in a red state according to embodiments of the disclosed technology. In the depicted embodiment of the disclosed technology, a red color is shown from the front side of the EFT module when the first electric potential element is engaged while the second, and third electric potential elements are disengaged.

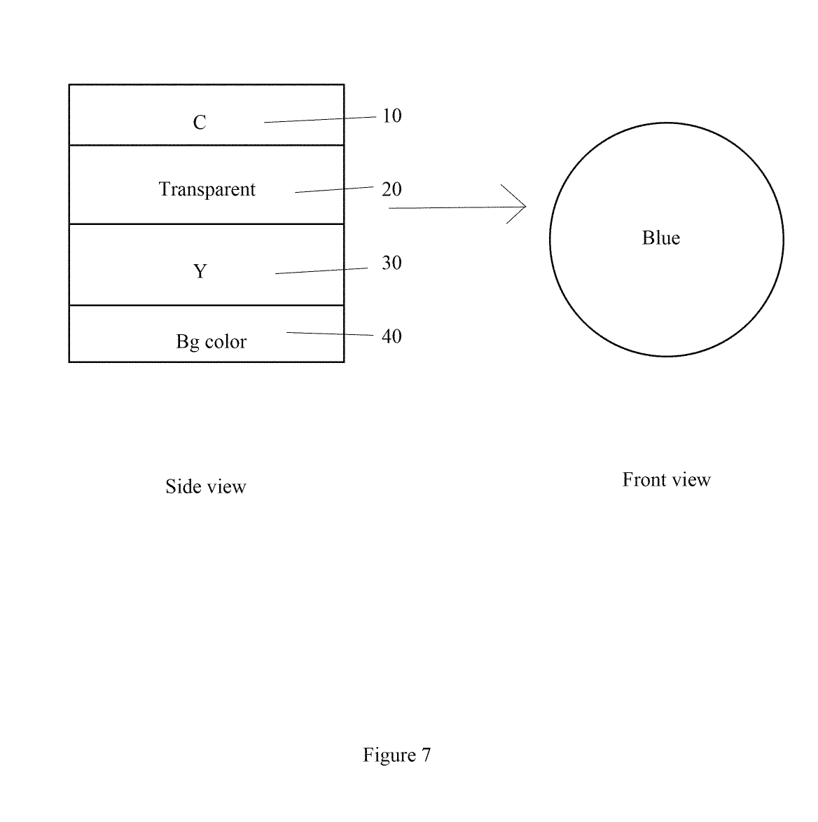

FIG. 7 shows the display in a blue state according to embodiments of the disclosed technology. The blue color may be shown from the front side of the EFT module when the third electric potential element is engaged while the first and second electric potential elements are disengaged.

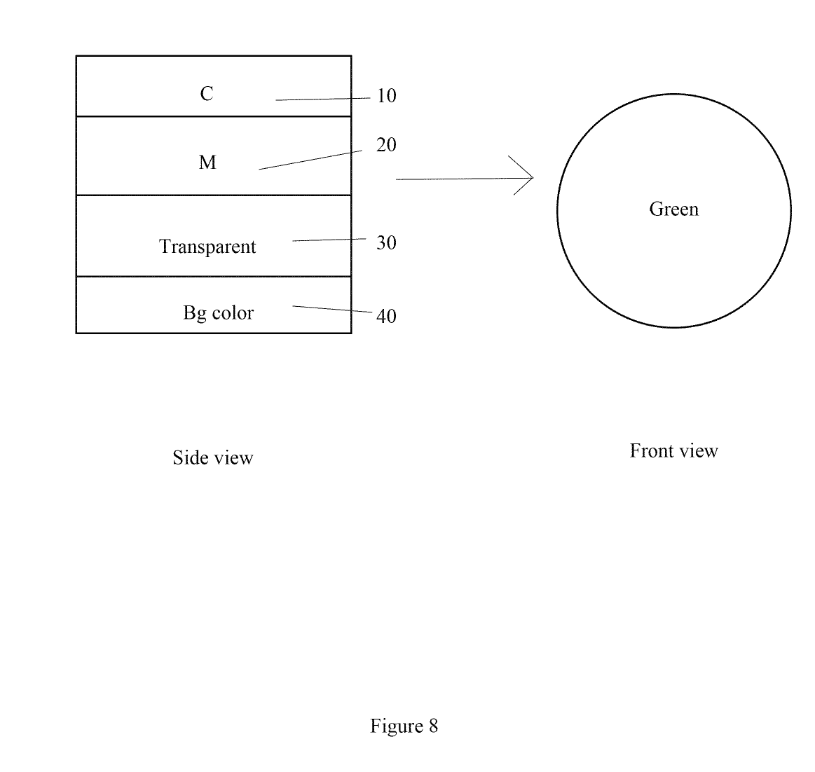

FIG. 8 shows the display in a green state according to embodiments of the disclosed technology. The green color may be shown from the front side of the EFT module when the second electric potential element is engaged while the first and third electric potential elements are disengaged.

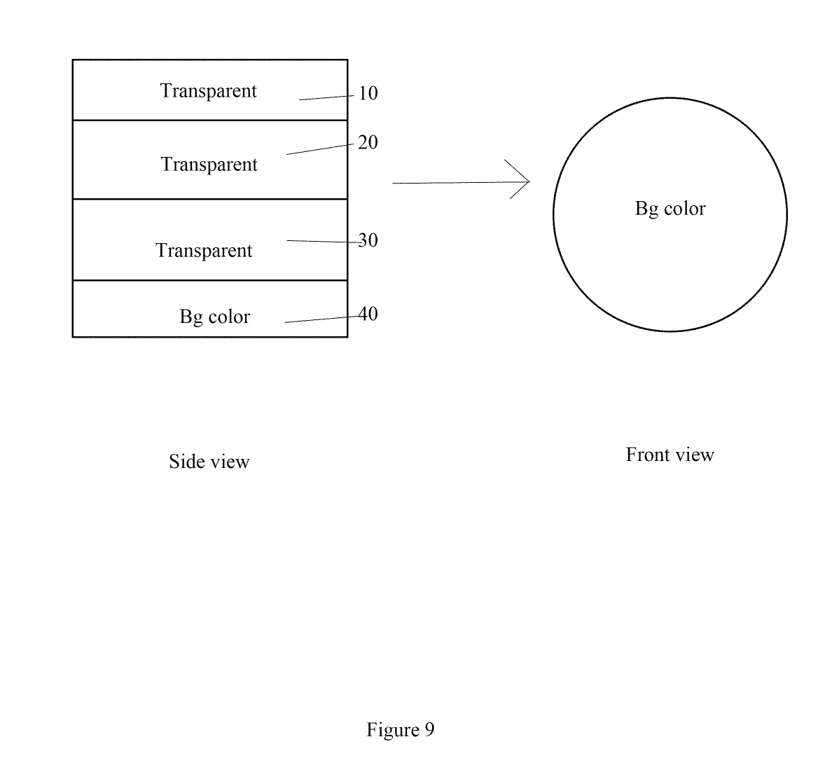

FIG. 9 shows the display in a semi-transparent state according to embodiments of the disclosed technology. In this state, the background color of the fourth oil layer 40 is visible through the transparent state of the first three layers 10, 20, 30. This background color may be apparent from the front side of the EFT module when the first, second, and third electric potential elements are engaged while the fourth electric potential element is disengaged.

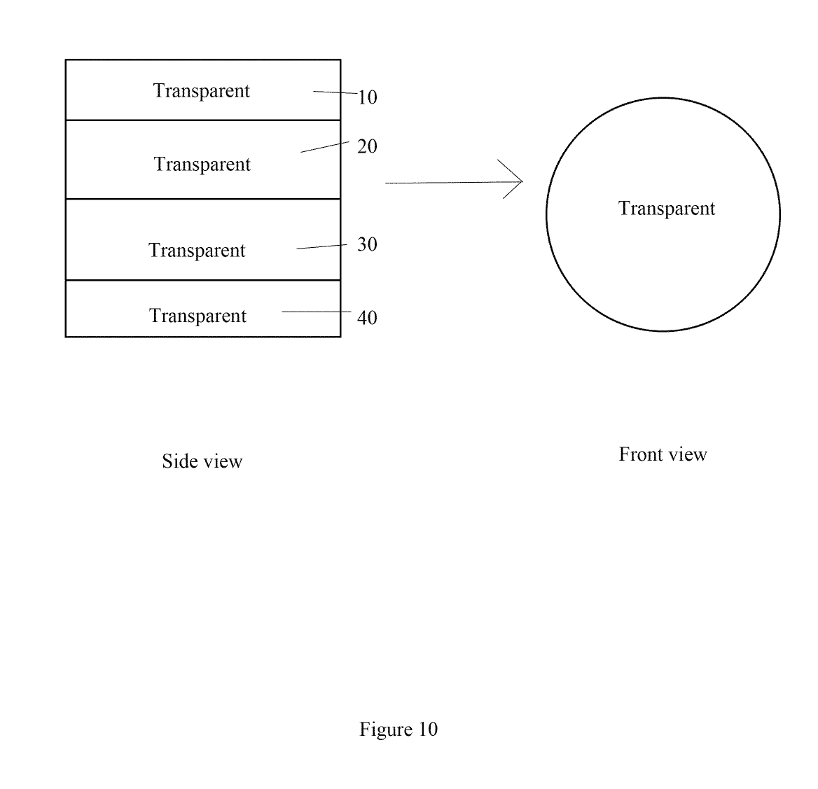

FIG. 10 shows the display in a fully transparent state according to embodiments of the disclosed technology. Transparency may be apparent from the front side of the EFT module when the first, second, third, and fourth electric potential elements are engaged. That is, light will travel through the front side in this arrangement. Alternatively, transparency may be apparent from the rear side of the EFT module when the first, second, third, and fourth electric potential elements are engaged.

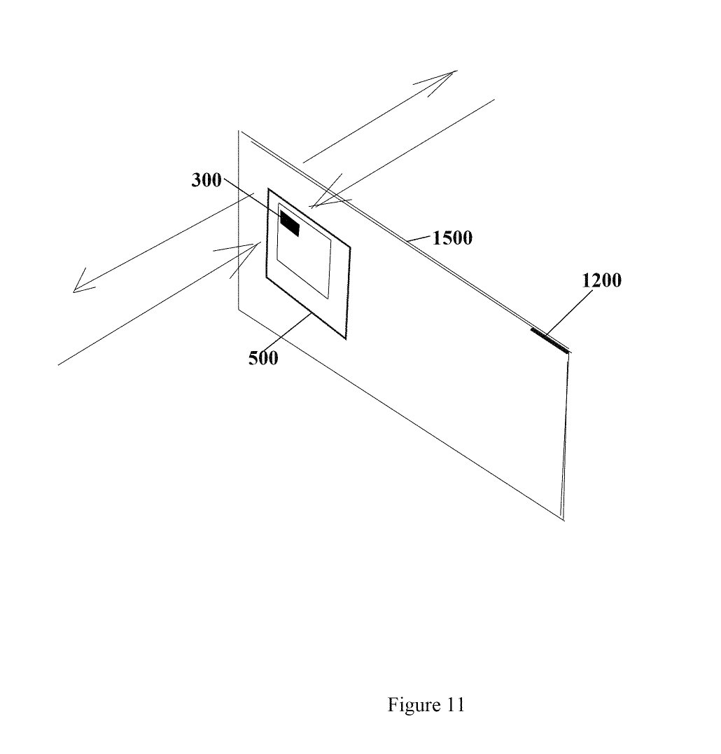

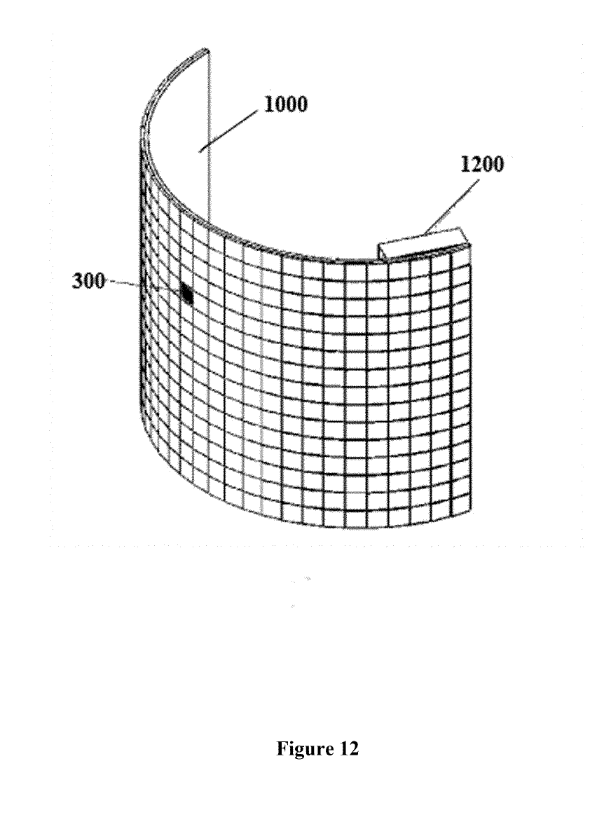

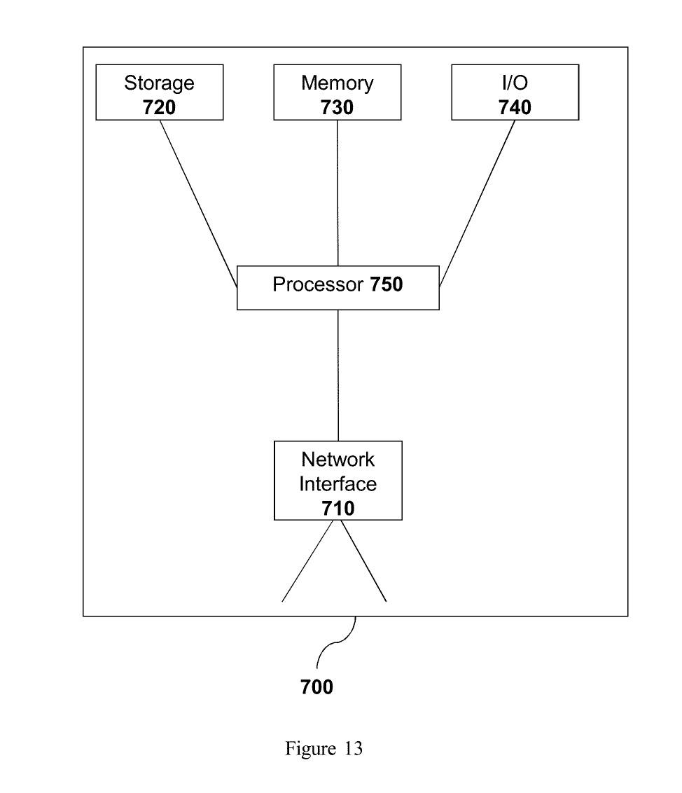

FIG. 11 shows a perspective stand-alone view of the display panel according to embodiments of the disclosed technology. FIG. 12 shows a perspective stand-alone view of the display panel with a display driver control according to embodiments of the disclosed technology. A pixel structure 300 is depicted making up the EFT modules which form the display panel 1000. A display driver control 1200 is connected to the entire panel for controlling the display. The display drive control 1200 may be operated by a processor, the function of which is described in greater detail with respect to FIG. 13. Typically, pixel structures have a certain structure height of about 10 to 500 μm or more. Moreover the pixel structures 300 may be glued to the underlying surface. This underlying surface is often a fluoropolymer surface so the bonding is rather weak mechanically due to the fact that the fluoropolymer is very hydrophobic.

FIG. 13 is a high-level block diagram of a microprocessor device that may be used to carry out the disclosed technology. The device 700 comprises a processor 750 that controls the overall operation of a computer by executing the reader's program instructions which define such operation. The reader's program instructions may be stored in a storage device 720 (e.g., magnetic disk, database) and loaded into memory 730 when execution of the console's program instructions is desired. Thus, the device 700 will be defined by the program instructions stored in memory 730 and/or storage 720, and the console will be controlled by processor 750 executing the console's program instructions.

The device 700 may also include one or a plurality of input network interfaces for communicating with other devices via a network (e.g., the internet). The device 700 further includes an electrical input interface for receiving power and data. The device 700 also includes one or more output network interfaces 710 for communicating with other devices. The device 700 may also include input/output 740 representing devices which allow for user interaction with a computer (e.g., display, keyboard, mouse, speakers, buttons, etc.).

One skilled in the art will recognize that an implementation of an actual device will contain other components as well, and that FIG. 13 is a high level representation of some of the components of such a device for illustrative purposes. It should also be understood by one skilled in the art that the method and devices depicted in FIGS. 1 through 12 may be implemented on a device such as is shown in FIG. 13.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

The claims, description, and drawings of this application may describe one or more of the instant technologies in operational/functional language, for example as a set of operations to be performed by a computer. Such operational/functional description in most instances would be understood by one skilled in the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mutt,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

What is claimed:

1. A modular EFT display, comprising:
a display panel (1000);
an EFT module (500), which includes a front side and a rear side, is located within an area of the display panel (1000);
a display driver control (1200);
a connector (510) included in the EFT module for carrying a plurality of electronic signals of different voltages;
a receptor (1100) included in the display panel (1000), wherein the connector (510) is configured to make contact with the receptor (1100);
an upper plate (100) disposed at the front side of the EFT module;
a first oil layer (10);
a first fluid layer (11) being a conductive fluid matter that is adapted to a first electric potential element;
a second oil layer (20) being a non-conductive fluid matter;
a second fluid layer (21) being a conductive fluid matter that is adapted to a second electric potential element;
a third oil layer (30) being a non-conductive fluid matter;
a third fluid layer (31) being a conductive fluid matter that is adapted to a third electric potential element;
a fourth oil layer (40) being a non-conductive fluid matter that is adapted to a fourth electric potential element;
a lower plate (200) disposed at the rear side of the EFT module; and
a pixel structure (300), wherein the (100), (10), (11), (20), (21), (30), (31), (40), (200) form an isolated space.

2. The modular EFT display of claim 1, further comprising:
a housing frame (400) made of elastic material forming as an insulating element embedding the pixel structure.

3. The modular EFT display of claim 2, further comprising:
another EFT module (600) controlled by the display driver control (1200) located on another location within the display panel (500).

4. The modular EFT display of claim 3, wherein the first oil layer contains oil of cyan color.

5. The modular EFT display of claim 4, wherein the second oil layer contains oil of magenta color.

6. The modular EFT display of claim 5, wherein the third oil layer contains oil of yellow color.

7. The modular EFT display of claim 6, wherein the fourth oil layer contains oil of a given background color.

8. The modular EFT display of claim 2, wherein black color is shown from the front side of the EFT module when the first, second, and third electric potential elements are disengaged.

9. The modular EFT display of claim 2, wherein white color is shown from the front side of the EFT module when the first, second, and third electric potential elements are engaged.

10. The modular EFT display of claim 2, wherein red color is shown from the front side of the EFT module when the first electric potential element is engaged while the second, and third electric potential elements are disengaged.

11. The modular EFT display of claim 2, wherein blue color is shown from the front side of the EFT module when the third electric potential element is engaged while the first and second electric potential elements are disengaged.

12. The modular EFT display of claim 2, wherein green color is shown from the front side of the EFT module when the second electric potential element is engaged while the first and third electric potential elements are disengaged.

13. The modular EFT display of claim 2, wherein the background color is shown from the front side of the EFT module when the first, second, and third electric potential elements are engaged while the fourth electric potential element is disengaged.

14. The modular EFT display of claim 2, wherein transparency is shown from the front side of the EFT module when the first, second, third, and fourth electric potential elements are engaged.

15. The modular EFT display of claim 2, wherein transparency is shown from the r side of the EFT module when the first, second, third, and fourth electric potential elements are engaged.
